(19) United States
(12) Patent Application Publication
(10) Pub. No.: US 2010/0306118 A1
(43) Pub. Date: Dec. 2, 2010

(54) System for process for remote determination of compliance status

(76) Inventors: Peter D. Kochevar, Vancouver (CA); Randall Ray, Troy, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 12/791,393

(22) Filed: Jun. 1, 2010

Related U.S. Application Data
(60) Provisional application No. 61/182,394, filed on May 29, 2009.

(51) Int. Cl. G06Q 99/00; G06F 17/30; G06K 5/00

(52) U.S. Cl. 705/317; 707/769; 235/380; 705/400; 707/E17.014

(57) ABSTRACT

A system for integrating and administering multi-organizational compliance monitoring of entities passing between the organizations. The system is configured to allow each organization to be individually responsible for and administer information related to the compliance status of an entity. The system increases an entity's mobility by allowing an organization other than the entity's home organization to determine the compliance status of the entity without additional compliance testing.

### RELATED APPLICATION

This application claims priority of U.S. Provisional Patent Application Ser. No. 61/182,394 filed May 29, 2009, which is incorporated herein by reference.

### FIELD OF THE INVENTION

The invention relates in general to a system and process for integrating and administering a multi-organizational compliance monitoring system, and in particular to a system and process for sharing inter-organizational information through a through a secure communications network.

### BACKGROUND OF THE INVENTION

The number of organizations mandating employee drug testing is rapidly growing. Particular occupational fields such as the construction industry depend on drug-free employees to maintain a safe working environment for the employee, coworkers, and innocent bystanders. Organizations whose employees handle hazardous materials such as chemical manufacturers or pharmaceutical discovery organizations must ensure that safety in the workplace is not undermined by an employee who is impaired or deficient in their knowledge or ability to safely perform their job function.

The construction industry has been a leader in establishing organizations that monitor the drug status of workers within that organization. The Management and Unions Serving Together (MUST) organization in Michigan and the MOST organization in northern Ohio are two examples for worker exchange systems (WES). While the drug testing programs of these local organizations work well within their own jurisdictions, there is at present little support for collaboration between jurisdictions. A worker who is part of the MOST program cannot now present his MOST ID card at a job in Michigan whose drug testing is administered by MUST and have his compliance information in the MOST program easily examined by authorized MUST safety personnel.

Thus, there is a need for systems and methods that allow local organizations to sharing inter-organizational information through a through a secure communications network without duplicative and unnecessary compliance or certification testing.

### SUMMARY OF THE INVENTION

A system for identifying compliance status of an entity is provided that includes organizational databases and Web servers, each in electronic communication with one of the organizational databases. A hub or other secure communication network electronically interconnects the Web servers and receives a query about the entity from one of the Web servers and a response from another Web server related to the query. The response identifies the compliance status of the entity. A process for determining the compliance status of the entity includes assembling a query at a local computer system and electronically communicating the query to a hub. The query is electronically transmitted to a target organization and a database administered by the target organization is queried. A response relating to the query, which identifies the compliance status of the entity, is electronically transmitted to the local computer system that initiated the query.

### BRIEF DESCRIPTION OF THE DRAWING

FIG. 1 is a schematic diagram illustrating local organizations in communication with a hub according to embodiments of the invention;

FIG. 2 is a schematic diagram illustrating an overall view of communication devices and mediums for linking local organizations according to embodiments of the invention; and

FIG. 3 is a flowchart of a process for implementing an embodiment of the invention.

### DETAILED DESCRIPTION OF THE PREFERRED EMBODIMENTS

The present invention provides a system and process for inter-organizational determination of worker and entity certification or compliance status. The inventive system has utility for allowing independent organizations to query other organizations to determine certification or compliance status of a worker or other entity that wishes to perform functions or is to be transferred outside their home or originating organization. Certification and compliance status items for workers and entities may include safety test results, job certifications, licensing exams, police records, presence on sexual offender lists, credit histories, drug testing information, handling restrictions, import/export restrictions, etc.

The system is configured to allow each organization to be individually responsible for and administer information related to the compliance status of an entity. The system increases an entity's mobility by allowing an organization other than the entity's home organization to determine the compliance status of the entity without additional compliance testing. The elimination of additional compliance testing increases efficiencies between organizations by preventing duplication of compliance status determinations, and thereby increases the efficiency whereby entities or workers may be transferred between organizations and occupational positions.

Systems and processes of the present invention function as a central hub communication arrangement that provides for cross-organizational communication and collaborative abilities while the autonomy of individual organizations is maintained. The communication allows for local control over testing methodologies, costs, filing and processing of grievances and administration of worker benefits and entity tracking. Drug testing is only one area in which local organizations operate. For example drug testing status may be administered by a local union branch that also serves to negotiate local contracts and administer benefits such as retirement benefits for the member workers. The inventive system allows greater flexibility for these local branches in accepting temporary or transfer workers depending on the needs in the geographical or other region. It is appreciated that other secure communication network architectures that are not hubs are also operative herein and illustratively include neural networks, chain, ring, mesh, tree, and bus. It is further appreciated that an encrypted network is a subset of a secure communication network.

As used herein the term “organization” refers to a system of like enterprises. Illustratively, an organization is an association of workers that serves the needs of the member workers, such as a trade union branch. Alternatively, an organization is represented by a business or research site of a company or a division therein. Organizations may be divided geographically, or merely by business structure. For example, a chemistry group in a drug-development company can be associated to form one local organization whereby a drug-safety group can be associated to form a second local organization. As used herein the term “entity” refers to person, livestock, plant, virus, object, material, or compound whether natural or man made. While the individual workers or synthesized compounds can readily be transferred throughout the meta-organization, tracking of the compounds and their prior testing status is easily managed by the association of the local organizations by the meta-organization.

As used herein a “hub” is a Web server, database, or other communication receiving, sending or processing system capable of receiving a query or transmitting a response and is synonymously referred to as a hub server herein.

In a preferred embodiment an inventive system is administered by a meta-organization. A meta-organization is an umbrella group to which all local certification and compliance testing organizations belong, much like trade unions, owners, and contractors belong to MUST for drug related testing. The meta-organization optionally has responsibilities illustratively including: establishing minimal drug testing standards for the member local organizations; minimal licensing and certification requirements, establishing a methodology and protocols for the electronic sharing of worker compliance information among the member local organizations; administering memberships of the local organizations; defining and enforcing policy; and ensuring that methodology is practiced correctly primarily through the appropriate use of supporting technology.

One of ordinary skill in the art recognizes that a meta-organization is not required to administer the inventive system. Each organization belonging or subscribing to the system need only agree with the other members of the system as to how system functions will be operated or achieved. Illustratively, each organization may contribute to the cost and operation of a central hub and the methods by which queries and responses are created are uniform by agreement. Optionally, a single organization may serve both as an individual compliance and certifying organization and as a system administrator to coordinate communications between multiple other organizations.

An advantage of the inventive system is that local organizations optionally remain responsible for the compliance and certification testing of individuals in their jurisdictions, maintaining testing information, issuing identification (ID) cards, providing compliance checking systems, and administering users of their systems. The meta-organization, if present, preferably facilitates the sharing of information among its members organizations and preferably does not house, maintain, determine, or otherwise administer compliance and certification testing of individuals or entities in any organization or independent thereof.

Although the invention is herein described as particular to a worker, the term “worker” is broadly used to describe any individual person, or another entity such as, for example, a legal entity, animal, livestock, organism, virus, apparatus, plate, container, or any other individually identifiable apparatus. For example, a cell line may be exposed to a drug or other chemical agent at one organization and is thereafter transferred to another organization. The inventive system allows for the second organization to query the first organization's database for the drug-exposure status of the cell line. Similarly, a construction worker wishing to perform duties at an organization geographically remote or merely organizationally remote from his home organization is able to have his drug testing status readily determined by the second organization by querying the database of the worker's home organization.

In an exemplary embodiment used for illustrative purposes, each local organization has its own methodology for checking the compliance of workers in their care with the drug testing rules that the organization defines. Each local drug testing organization administers one or more electronic databases containing the compliance information for each worker under their responsibility, and the local organizations are electronically connected such as using the Internet. Each local organization preferably has a unique ID number, optionally assigned by the meta-organization. The local organization ID number is preferably incorporated into a portion of the worker ID number such that a query can more easily and properly identify the home organization of a worker being queried, much like a routing number and account number on a check serves to properly deliver the check to a bank branch holding an account and identify the particular account within that branch. The combination of the local worker ID number and the local organization ID number forms a unique global ID for each worker across all local organization systems.

In embodiments, a worker may optionally have an ID card imprinted with their local worker ID number and the ID number of the local drug testing organization to which they belong. An identification card may optionally contain identifying information such as a unique global ID for the associated worker. IDs are illustratively in the form of one- or two-dimensional barcodes, encoded in a magnetic strip, or within an RFID chip so that the IDs can be read off the card automatically by an electronic scanner. In embodiments, ID cards may be supplied and issued by local organizations, but the cards might have to conform to a standard determined by the meta-organization. Alternatively, a meta-organization issues all ID cards to be distributed by the local organizations.

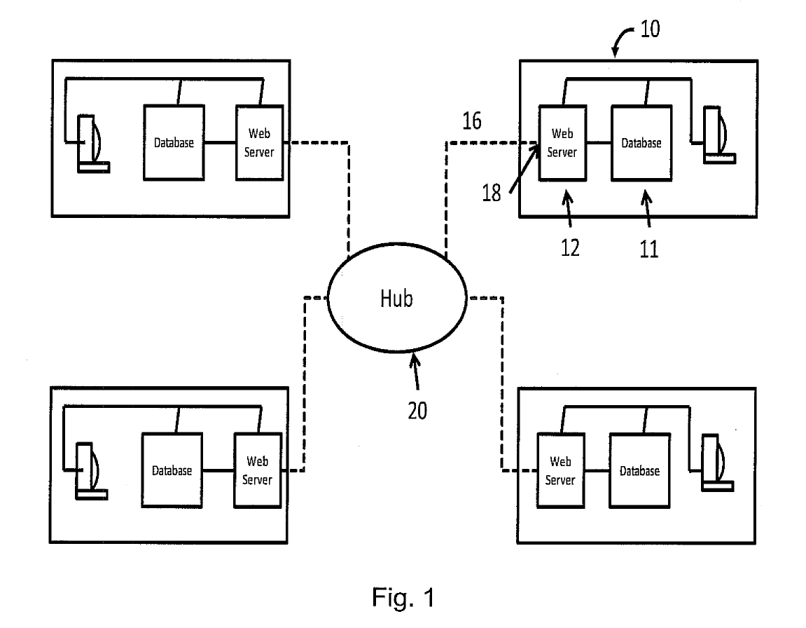

FIG. 1 is a high-level schematic diagram of a compliance and certification testing and status communication system 105 according to the present invention. A local organization has at least one site 110. In one embodiment of the invention, the site 110 includes an organizational database 111 and a Web server 112. The organizational database 111 and the Web server 112 are connected together as by a local network connection 113.

The organizational database 111 has sufficient random access memory to operate a bootable operating system and related executable computer programs. The organizational database 111 also possesses one or more processors that are powerful enough to assemble responses and store query information and the results. In one embodiment of the invention, the organizational database 111 and the Web server 112 include an administrator terminal 114 to permit access to the executable program(s).

The Web server 112 optionally includes a network interface and a firewall application 118 to permit the Web server 112 to communicate to a wide-area network 116 while prohibiting unauthorized access to the Web server 112. The wide-area network 116, in one embodiment of the invention, is the Internet.

All the local organizations are linked via a hub 120 that is optionally administered by a meta-organization. A network that links all of the member local organizations preferably uses an established communication system such as the Internet, preferably, the World Wide Web. Individual network connections can be a 28.8k or 56k baud conventional telephone line, an ISDN line, or a more expensive and faster connection method such as DSL, a T1 line or a wireless connection. The Internet includes the internet service provider (ISP) of each of the local organizations to the extent that these sites are not self-hosting. While four such sites 110 are shown in FIG. 1, it is appreciated that there may be dozens or even hundreds of such sites.

Compliance data sharing protocols may preferably be based on Extensible Markup Language (XML) that may be passed around the network using Hypertext Transfer Protocol Secure (HTTPS) which serves as the secure, encrypted version of the HTTP protocol that currently underlies World Wide Web communications. It is appreciated that any known or custom developed communication protocols are operative within the inventive system and method. In one embodiment of the invention, communication over the wide-area network is performed by some secure method such as a point to point tunneling protocol (PPTP), which creates what appears to be a virtual private network. Illustratively, a meta-organization can develop individual communication protocols that are exclusive to that meta-organization. This may improve the security of private information transmitted throughout the network. Alternatively, any type of encryption known in the art is operable herein as a means of coding communications such as queries and responses.

In a preferred embodiment, the compliance sharing protocol uses two message types: a request or query for compliance or certification information; and a response to the query. A request is initiated by an authorized user at a terminal 114 in a local organization 110. Each terminal 114 at the local organization 110 has a display and a graphical user interface (GUI), such as a mouse, or some other method of recording the authorized user's input. In an example use of the embodiment, a worker identifies themselves to an authorized user at a local organization 110 by presenting an identification card, photo ID such as a license, passport, social security card or the like. The request for compliance or certification information may optionally contain the worker's individual ID number issued by their local organization and the local organization ID number issued by the meta-organization that identifies the organization with jurisdiction over the worker. Other data is illustratively included in the request for compliance information that would help make people using the system more accountable, and would help in resolving questions or disputes that may arise. Optionally a request may also contain the name and ID of the administrator requesting information, the IP address of the terminal 114 that was used in making the request, the job site where the request was made, the time and date the request was made, the name of the local organization to which the request originated, and other tracing and monitoring information.

A meta-organization hub 120 system optionally records each request that is submitted along with identifying information such as the time and date the request was made, the identification information of the requester, the identification of the requesting organization and the details of the submitted request. These details can be privately held or may be made available to any requesting organization. In an illustrative example, a meta-organization may supply each member organization with a report of all the request information on a recurring basis such as monthly. This way each member organization may identify their usage rates and the mobility of the workers within their organization and into their organization from outside or otherwise non-local organizations.

Optionally in an embodiment, a meta-organization may be funded by charging usage fees to member organizations in proportion to the number of requests received from each organization. For example, a large local organization may have many workers that regularly travel into the organization for temporary or permanent duties. The organizations with a large influx of transitory workers may submit a relatively larger number of requests than other local organizations on the same system, and will have a higher bill representing their increased usage relative to other organizations, whereas a local organization that has little system usage will pay less to maintain and operate the system.

Optionally in an embodiment, the hub 120 may compare the requesting information against a database to determine whether the requester is authorized to make the request. Illustratively, a particular organization or worker at that organization may have been recently terminated or is otherwise not allowed access to the system. The central database contains the information identifying each authorized requester, their requesting status and whether a request is proper at the time and date the request is made. The authorization check of the requestor serves as a security measure to prevent unwanted or uncontrolled requests of the system and protects the privacy of the individual workers in each member organization and the information of the organizations themselves.

In embodiments, the response message is sufficient to identify to the requesting organization or the requester whether the worker's certification or compliance status (e.g., has appropriate licenses, usage of drug status, etc.) is appropriate. For example for a drug test inquiry, a response message may optionally contain the worker's name, an indication of whether the worker has or has not passed a recent drug test, the test expiration date if the worker passed a recent drug test, the reason why they have not passed a recent drug test and the date when they will be eligible to be retested, and optionally other ancillary information such as the worker's picture, their contact information, their craft, their current employer, the employer's contact information, or other matters desired by the requester or the response providing organization. Thus, a response will properly identify the worker associated with the information such that the requestor can properly determine whether the information is related to the desired worker. For example, a photograph provided with a response will readily allow a requester to confirm that the information received is related to the worker for whom drug-testing status is sought.

Optionally in an embodiment, a response may include an identification number such as the identification number used to make the request. A requester may compare the response number with the number provided in the query. In a preferred embodiment the identifying information in the response is information that is not readily used to identify a worker by unauthorized observers. Illustratively, an identifying number is preferred over a photograph or a name as an unauthorized observer could readily identify the query worker and associate them with the response information if photographs are transmitted. This protects the privacy of the worker that is the subject of the query.

In embodiments as illustrated in FIG. 1, the inter-organizational system for certification and compliance testing may be arranged as a hub 120 and spoke 110 network 105 with the meta-organization administering the hub 120 and each local organization operates at the end of a spoke 110. Communication between each local organization through the hub is facilitated by each local organization 110 using a Web server 112 connected via the Internet 116 to a hub Web server 120 that is operated by the meta-organization. The Web server 112 for each local organization is connected to that organization's organizational database 111. A query is optionally made by a requester through an organizational database 111 or other interface such as a computer terminal 114. The query is communicated to the organizational Web server 112 for transfer to the hub 120. Optionally, the organizational database 111 and the organizational Web server 112 are housed in the same apparatus. Optionally, an organization is equipped with several remote terminals 114 in communication with the organizational Web server 112.

In embodiments, the hub server 120 may be restricted to communicate only with local Web servers 112 that the meta-organization has registered to use the inter-organizational system 105. An embodiment of an authorized user system may be achieved by each local organization communicating to the meta-organization administrators the IP address of their local Web server during an initial one-time setup. The hub server 120 is optionally configured to only accept connections from computers that have IP addresses already stored in a database connected with the hub server 120 and to exclude those not recognized by the system. In a similar manner, the local organization Web servers 112 may be configured to only accept results delivered from the hub server 120 as identified by an IP address that is associated with the hub server 120.

In embodiments, additional security may be achieved by requiring security protocols at each local organization 110. Illustratively, each administrative user at a local organization may be required to establish authentication mechanisms for access to the local Web server 112. Preferably, authorized administrative users of the inter-organizational certification and compliance testing system 105 must first authenticate themselves within their own local testing system 110, for instance, by supplying a username and password. Thus, the meta-organization within the hub 120 may not have to maintain its own list of users with a separate set of usernames and passwords. It is appreciated that the meta-organization may wish to maintain independent authentication protocols in addition to those at each local organization. Illustratively, each local organization may be assigned a passkey that is known only to the authorized users at the local organization 110 or is stored in the local organization Web server 112 for automated authentication upon submission of either a query or a response. By limiting the number of passkeys to the number of authorized organizations, the meta-organization does not need to update the authorized organization database each time a new authorized user at a local organization accesses the system.

In an embodiment, each local organization may be responsible for creating a means within their own system 110 for requesting information for a worker or entity not registered with their system, and for rendering any results returned by the meta-organization. As an illustrative example, a meta-organization may provide a form on a Web site where the unique global ID (the worker's local ID plus the ID of the local organization that administers that worker) of a worker is entered, and then the compliance information would be displayed on a subsequent Web page.

If for example with continued reference to FIG. 1, a request for drug testing information about a non-local worker is made by a local administrator, an appropriate XML request is assembled by the local system 110 and is sent to the meta-organization's hub Web server 120. The hub Web server 120 then shuttles the request to the Web server 112′ of the target organization 110′ that oversees the worker in question as identified in the query. The drug use compliance information resides in an electronic database administered by each local organization allowing computerized or otherwise automated access to their compliance information. The local Web server 112′ at the target organization 110′ extracts the drug testing information from its database 111′ and sends the result as an XML file back to the hub 120. Finally, the hub 120 directs the result to the Web server 112 at the organization 110 that initiated the request where the result information could be rendered as a Web page. A representative of the querying organization 110 may then associate the received drug-testing status information with the worker who is the subject of the query. Thus, a worker is able to have drug-testing status information readily obtained from their home local organization 110′ at any other member local organization without the need for repetitive and unnecessarily duplicative drug testing.

It is appreciated that in embodiments more than one meta-organization or association of local organizations may be further associated. If the two meta-organizations share common communication protocols and querying protocols are otherwise able to accept requests from each other, a worker associated with one meta-organization may have certification or compliance testing status information obtained from a querying local organization that is not directly associated with his home meta-organization. Alternatively, a second meta-organization may act as an alternative local organization whereby the hub of the second meta-organization may be used to query the hub of the first meta-organization. The hub of the first meta-organization may be programmed to receive queries from an IP address associated with another hub as well as from an associated local organization.

In embodiments, multiple hubs may be readily associated. The number of associated hubs is not limited thereby allowing a spider web of communicating hubs to be formed. For example, each state, company, business or research site may be served by a single meta-organization hub that processes queries and responses for the local organizations associated with the hub. The hubs of two or more states may further be associated to form an association of meta-organizations that will allow compliance or certification testing status information to be shared among a larger geographical region. If a particular state has alternative methods of establishing compliance or certification testing status or requires testing less frequently than a querying local organization accepts, information relating to the methods used and date of the last administered test may readily be transferred to the querying local organization whereby an authorized agent may determine whether the worker is in compliance with local testing rules or requirements.

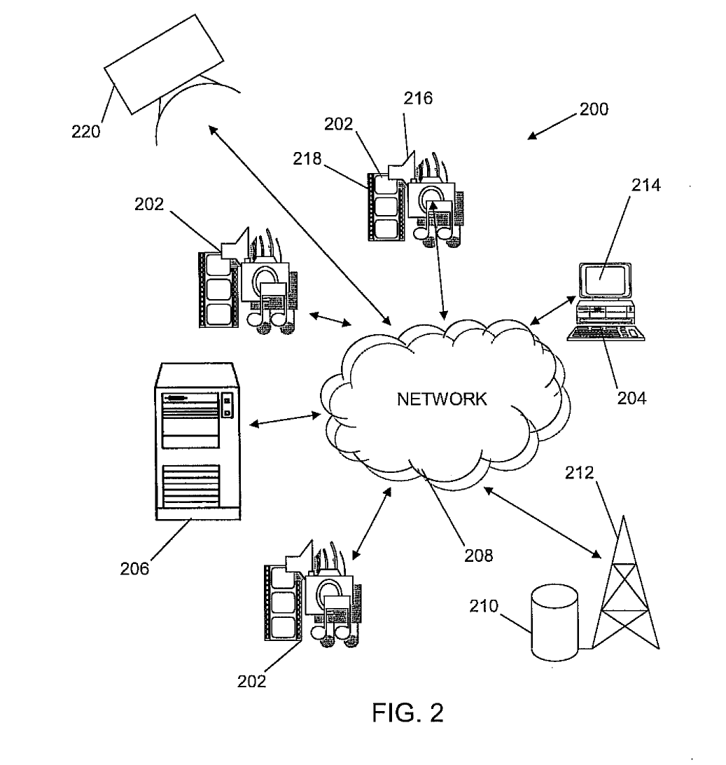

FIG. 2 is a schematic diagram illustrating an overall view of communication devices and mediums for linking local organizations for the purpose of obtaining compliance and certification status of people and entities according to embodiments of the invention. The elements of the embodiments of the hub and spoke network described in FIG. 1 are included in the networks and devices of FIG. 2.

The system 200 includes multimedia devices 202 and desktop computer devices 204 configured with display capabilities 214. The multimedia devices 202 are optionally mobile communication and entertainment devices, such as cellular phones and mobile computing devices that are wirelessly connected to a network 208. The multimedia devices 202 have video displays 218 and audio outputs 216. The multimedia devices 202 and desktop computer devices 204 are optionally configured with software with a graphical user interface (GUI) for carrying out the obtaining of compliance and certification status of people and entities from member organizations according to embodiments of the invention. The network 208 is optionally any type of known network including a fixed wire line network, cable and fiber optics, over the air broadcasts, satellite 220, local area network (LAN), wide area network (WAN), global network (e.g., Internet), intranet, etc. with data/Internet capabilities as represented by server 206. Communication aspects of the network are represented by cellular base station 210 and antenna 212. In a preferred embodiment, the network 208 is a LAN and each remote device 202 and desktop device 204 executes a user interface application (e.g., Web browser) to contact the server system (e.g., hub 120 of FIG. 1) 206 through the network 208. Alternatively, the remote devices 202 and 204 may be implemented using a device programmed primarily for accessing network 208 such as a remote client.

The software for obtaining compliance and certification status of people and entities, of embodiments of the invention, may be resident on the individual multimedia devices 202 and desktop computers 204, or stored within the server 206 or cellular base station 210.

In a further embodiment, after the initial communication between a querying organization and a responding organization is authenticated and established by a meta-organization hub, subsequent communication between the querying organization and responding organization is conducted directly without the hub. In the embodiment, the fundamental roles of the “hub” in the information exchange or worker exchange system (WES) is to authenticate that two organizations are authorized to use the system (WES), and to establish a temporary, secure communications channel between the two organizations. Once a channel is set up, all further communications might take place solely between the registered servers of the local organizations (via the network 208 alone, and without passing through the hub 206), at least for some period of time or number of requests.

For example, in an embodiment a hub is contacted by a local organization requesting compliance information from another local organization. The hub might facilitate the setting up of a secure communications channel by generating a long random character string that serves as a transaction ID. The hub would then securely send the transaction ID to the two local organization servers, as well as the IP addresses and URLs that the two local servers can use to contact one another directly. The requesting local organization server would then send a secure request message to the other local organization server with the transaction ID who would then compare the ID with what it was sent by the hub. If the two IDs match and the IP address of the requester is as expected, then the other local organization server would respond to the request, either just this one time or perhaps for multiple requests over some defined time span.

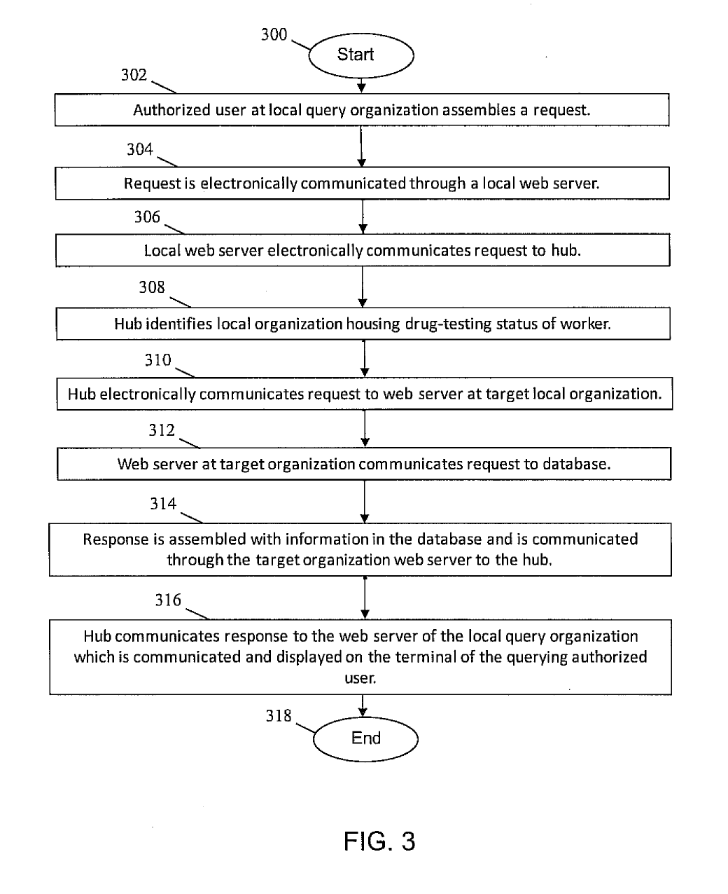

FIG. 3 is a flowchart for implementing a method for determining compliance and certification status of an entity according to an embodiment of the invention. The process starts (block 300) with an authorized user at a local organization assembling a request for an entity's compliance or certification status (block 302). The request is electronically communicated through a local Web server (block 304), and the Web server electronically communicates the request to a hub (block 306). Subsequently, the hub identifies which local organization controls the records for the compliance or certification status (e.g., drug testing status of a worker) of the entity that is the subject of the request (block 308). Following the identification of which target local organization the entity that is the subject of the request belongs to, the hub electronically communicates the request to a Web server for that target organization (block 310). Upon receiving the request, the Web server for that target organization communicates the request to a database within the target local organization (the home organization of the worker for whom drug testing compliance information is being requested) (block 312). Following the reception of the request by the database, information is obtained from the database and a response is formed with the information, and the response is sent by the target organization's Web server back to the hub (block 314). The hub communicates the response to the Web server of the local querying organization (i.e., the organization that requested drug testing information), which is displayed on a terminal belonging to the authorized querying user (block 316), and the process concludes (block 318).

One skilled in the art will readily appreciate that the present invention is well adapted to carry out the objects and obtain the ends and advantages mentioned, as well as those inherent therein. The present methods, systems, procedures, and specific apparatuses described herein are presently representative of preferred embodiments, are exemplary, and are not intended as limitations on the scope of the invention. Changes therein and other uses will occur to those skilled in the art which are encompassed within the spirit of the invention as defined by the scope of the claims.

1. A system to identify compliance status of an entity comprising:
a plurality of organizational databases;
a plurality of Web servers, each in electronic communication with one of said plurality of organizational databases;
a hub electronically interconnecting said plurality of Web servers;
said hub receiving a query about the entity from a first of said plurality of Web servers and a response from a second of said plurality of Web servers related to said query, said response identifying the compliance status of the entity.

2. The system of claim 1 wherein each said plurality of organizational databases is administered by a single organization.

3. The system of claim 1 wherein the entity is a person, a legal entity, animal, livestock, organism, virus, compound, apparatus, plate, container, or an individually identifiable apparatus.

4. The system of claim 1 wherein each of said plurality of organizational databases contains information specific to the compliance status of the entity.

5. The system of claim 4 wherein compliance status is at least one of safety test results, job certifications, licensing exams, police records, presence on sexual offender lists, credit histories, drug testing information, handling restrictions, or import/export restrictions.

6. The system of claim 4 wherein each of said plurality of organizational databases contains information of at least one of: an identification number for an organization hosting one of said plurality of databases; an individual's worker identification number; an individual's name; an indication of whether an individual has passed a drug test; a drug test expiration date; a reason why an individual failed the drug test; a date an individual is eligible to be retested; an individual's picture; an individual's contact information; an individual's craft; an individual's current employer; or an individual employer's contact information.

7. The system of claim 1 further comprising an identification card containing information specific to a single individual.

8. The system of claim 7 wherein said identification card contains a worker identification number and an organization identification number.

9. The system of claim 8 wherein said numbers are numerical, bar coded, contained in an RFID tag, encoded in a magnetic strip, or combinations thereof.

10. The system of claim 1 wherein said hub is electronically interconnected with said plurality of Web servers via an Internet connection; wherein the compliance status is provided using Extensible Markup Language (XML) protocols that are passed through said Internet connection using Hypertext Transfer Protocol Secure (HTTPS).

11. The system of claim 1 wherein said hub is electronically interconnected with said plurality of Web servers via a point to point tunneling protocol (PPTP).

12. The system of claim 1 wherein said hub records the query along with a series of identifying information including at least one of: a query time, query identification information of a requester, identification of a requesting organization and details of the query.

13. The system of claim 12 wherein said hub compares the series of identifying information against a database to determine whether the requester is authorized to make the request.

14. The system of claim 1 further comprising a billing meter routine based on usage of said system.

15. The system of claim 1 wherein said hub is restricted to communicate only with said plurality of Web servers that are registered to issue the query.

16. The system of claim 15 wherein said plurality of Web servers are registered with their Internet protocol (IP) address.

17. The system of claim 1 wherein said plurality of Web servers are configured to only accept said response delivered from said hub as identified by an IP address that is associated with said hub.

18. The system of claim 1 wherein an initial communication between a querying one of said plurality of Web servers and a responding one of said plurality of Web servers is authenticated and established by said hub, and subsequent communication between said querying one of said plurality of Web servers and said responding one of said plurality of Web servers is conducted directly without passing through said hub for a defined period of time or number of additional queries.

19. The process of claim 1 wherein the electronic communication is via a secure or encrypted channel.

20. A process of determining a compliance status of an entity comprising:
assembling a query in a local computer system;
electronically communicating said query through a secure communication network;
electronically transmitting said query to a target organization;
querying a database administered by said target organization;
electronically transmitting a response related to said query to said secure communication network, said response identifying the compliance status of the entity; and
electronically communicating said response from said secure communication network to said local computer system.

21. The process of claim 20 wherein the entity is a person, a legal entity, animal, livestock, organism, virus, compound, apparatus, plate, container, or an individually identifiable apparatus.
